(19) United States
(12) Patent Application Publication
(10) Pub. No.: US 2008/0005204 A1
(43) Pub. Date: Jan. 3, 2008

(54) Systems and Methods for Applying Retention Rules

(75) Inventors: Bohdan S. Prus, Alpharetta, GA (US); Samuel H. Russ, Lawrenceville, GA (US)

Correspondence Address: Scientific-Atlanta, Inc.;Attn: Brook Lafferty, 5030 Sugarloaf Parkway, Lawrenceville, GA, 30044, US

(73) Assignee: SCIENTIFIC-ATLANTA, INC., Lawrenceville, GA (US)

(21) Appl. No.: 11/428,356

(22) Filed: Jun. 30, 2006

(51) Int. Cl. G06F 17/30

(52) U.S. Cl. 707/205

(57) ABSTRACT

Systems and methods for applying media retention rules are disclosed. One embodiment of a method for applying media retention rules comprises recording instances of media content to a first storage medium associated with a digital media recorder, detecting that a second storage medium is available for storing and maintaining additional instances of media content associated with the digital media recorder and, at a time after detecting that the second storage medium is available for storing and maintaining additional instances of media content, determining at least one of the instances of media content stored to the first storage medium or second storage medium can be deleted based on a retention policy that applies selected media retention rules associated with the instances of media content based on the storage medium to which the media content is stored.

### CROSS-REFERENCE TO RELATED APPLICATIONS

This application is related to co-pending U.S. patent application entitled “DIGITAL MEDIA DEVICE HAVING SELECTABLE MEDIA CONTENT STORAGE LOCATIONS”, having Ser. No. ______ [Attorney Docket No. A-11167; 191930-1650] and filed on the same day as, and with identical inventorship as, the present application. The related co-pending patent application listed above is hereby incorporated by reference in its entirety into the present disclosure.

### BACKGROUND

1. Technical Field

The present disclosure generally relates to digital media recording devices, and more specifically, to managing media content associated with a digital media recording device.

2. Description of the Related Art

Digital media recording devices can be used for recording media signals, such as audio and/or video signals, in a digital format. Such devices may also be used for the storage and playback of such signals. Specific examples of such digital media recording devices are a Digital Video Recorder (DVR) and a Personal Video Recorder (PVR).

In general, a DVR may be used to schedule and record future television programs, for buffering live television programs in a time-shift buffer, and/or playback of the digitally recorded media. The incoming media signals may be received, potentially decrypted and/or encoded, and digitally stored on a storage medium. The storage medium is commonly a non-volatile storage device such as a hard disk drive (HDD) (i.e., hard drive), among other acceptable mediums. Such an HDD can write the digital media data on a magnetic surface of the HDD disk platters and read the media data at later times for playback.

Conventional DVRs include an HDD located inside the housing of the DVR for storing the media data. This HDD may also have catalog information related to the media data stored on the HDD. The catalog information may include information about associated media data, such as guide information (i.e., title, actors, genre, program description, channel, time, etc.), recording date, and/or trick play information. The DVR may include logic for determining which of the media data stored to the HDD can be deleted at a particular opportunity, and the rules may use the catalog information for accomplishing this purpose. For example, such rules can be applied to delete shows being older than a predetermined length of time. According to some embodiments, the rules can specify that the associated media data that meets the rules can be deleted at a time when space is needed (e.g., in order to record another instance of media data).

Some DVRs include the capability of attaching an external HDD to the DVR. However, because the external HDD may be connected and/or disconnected from the DVR, special considerations for managing the media content stored to the devices are needed. Accordingly, the present disclosure includes a number of potential embodiments for carrying out media data management in such an environment.

### BRIEF DESCRIPTION OF THE DRAWINGS

The components in the drawings are not necessarily to scale relative to each other. Like reference numerals designate corresponding parts throughout the several views.

FIG. 1 depicts a block diagram of an arrangement of a digital video recorder (DVR) in accordance with embodiments of the present disclosure.

FIG. 2 depicts a block diagram of selected system components of an exemplary embodiment of the DVR of FIG. 1.

FIG. 3 depicts an embodiment of a data storage configuration that can be used in association with the internal and/or external storage of the DVR 102 of FIG. 2.

FIG. 4 depicts another exemplary embodiment of data storage configuration that can be used in association with the internal and/or external storage of the DVR of FIG. 2.

FIG. 5 is a process flow diagram depicting an exemplary embodiment of a process for selecting a retention policy for applying media retention rules to media content stored to one or more storage devices, such as internal storage and/or external storage of the DVR of FIG. 2.

FIG. 6 depicts a flow diagram of an exemplary embodiment of a process for applying media retention rules according to a media retention policy selected according to the process of FIG. 5.

FIG. 7 depicts a flow diagram of an exemplary embodiment of a process for copying and/or moving of media data from one or more associated storage devices of the DVR of FIG. 2 to another storage device of the DVR of FIG. 2.

### DETAILED DESCRIPTION

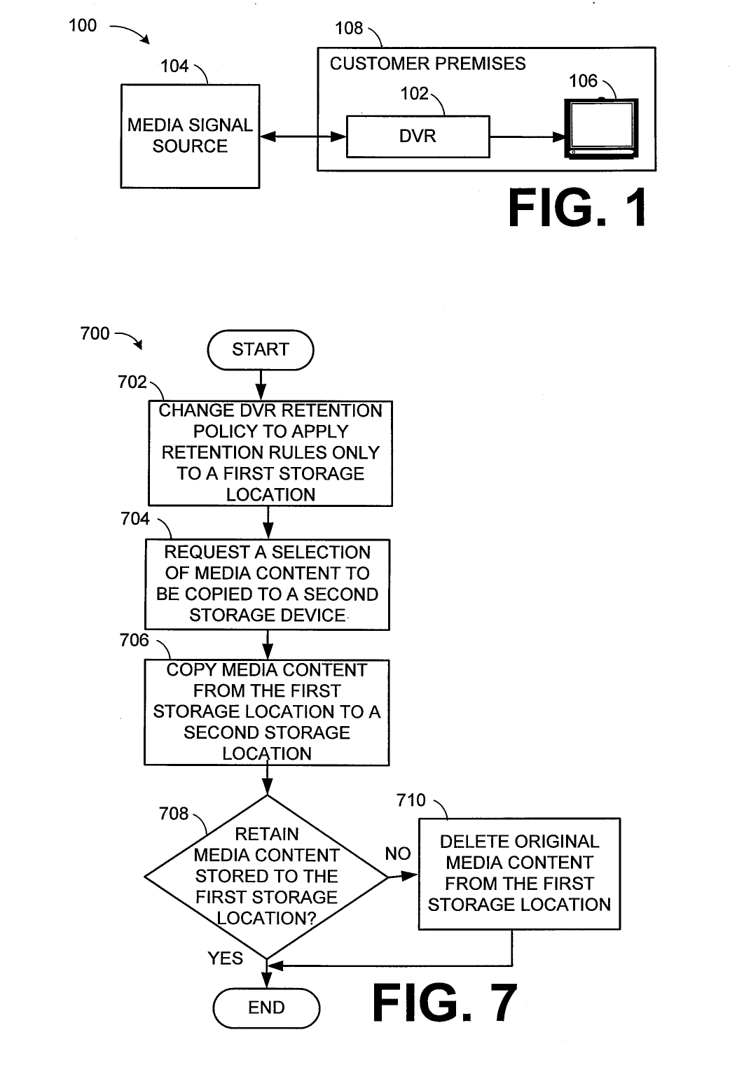

FIG. 1 depicts an embodiment of an arrangement 100 of a digital media recording system in accordance with selected embodiments of the present disclosure, among others. According to some embodiments, the digital media recording system includes a digital media device configured to record media content, such as, among others, video and/or audio content. For example, such a digital media device is depicted in FIG. 1 as digital video recorder (DVR) 102. However, according to some embodiments, the digital media device is, among other, devices used for recording digital media, a personal video recorder (PVR), a personal digital recorder (PDR), a personal computer, laptop computer, and/or personal digital assistant (PDA), among other electronic devices configured to execute media recording capabilities.

According to some embodiments, DVR 102 is also embedded within, or otherwise associated with, other electronic devices such as a cable television set-top box (STB), a tuner, a television, and/or a satellite-television receiver, or a playback device, such as a television, among others.

Media content is also referred to herein as media programs or media programming. Some examples of media programming used herein include, but are not intended to be limited to, television programs and radio programs. An instance of media programming or media content could be, for example, a recording of a television show (e.g., an episode of Smallville). A series of media programming could be, for example, a number of episodes of a television show (e.g., the last five recordings of Smallville).

The media content is recorded by the digital media recorder and stored as media data. In some instances, such media data is encoded audio and/or video signals, among other representations of the media content that is in a form suitable for processing by DVR 102. Such media signals could be analog and/or digital signals.

DVR 102 is configured to receive media signals from a media signal source 104, and is also in communication with a playback device, such as television 106. According to some embodiments, the playback device is a computer display, portable device, or audio receiver, among other devices capable of emitting or displaying media.

Media signal source 104 is any of a number of sources of analog and/or digital media signals, such as video and/or audio signals. According to some embodiments, media signal source 104 is, for example, among others, a satellite television source, an over-the-air broadcast source, a cable-television (CATV) system, or a server configured to stream, or otherwise provide, media signals over a network (i.e., LAN., WAN, Internet, etc.).

In some instances, media signal source 104 also transmits additional network data, including Internet traffic, teletext, closed-captioning, and/or programming information, among others. Media signal source 104 transmits such signals to DVR 102, which is located in one implementation, among others, remotely at a customer premises 108. Although only one media signal source is depicted, in some embodiments DVR 102 receives media signals from more than one media signal source. For example, in one such embodiment, DVR 102 receives signals from a CATV system as well as an over-the-air antenna.

Television 106 receives and emits signals from DVR 102 that represent the recorded (and unrecorded) media signals. For example, television 106 emits, among others, recorded audio and/or video signals. According to some embodiments, television 106 also displays any windows associated with a graphical user interface generated by DVR 102.

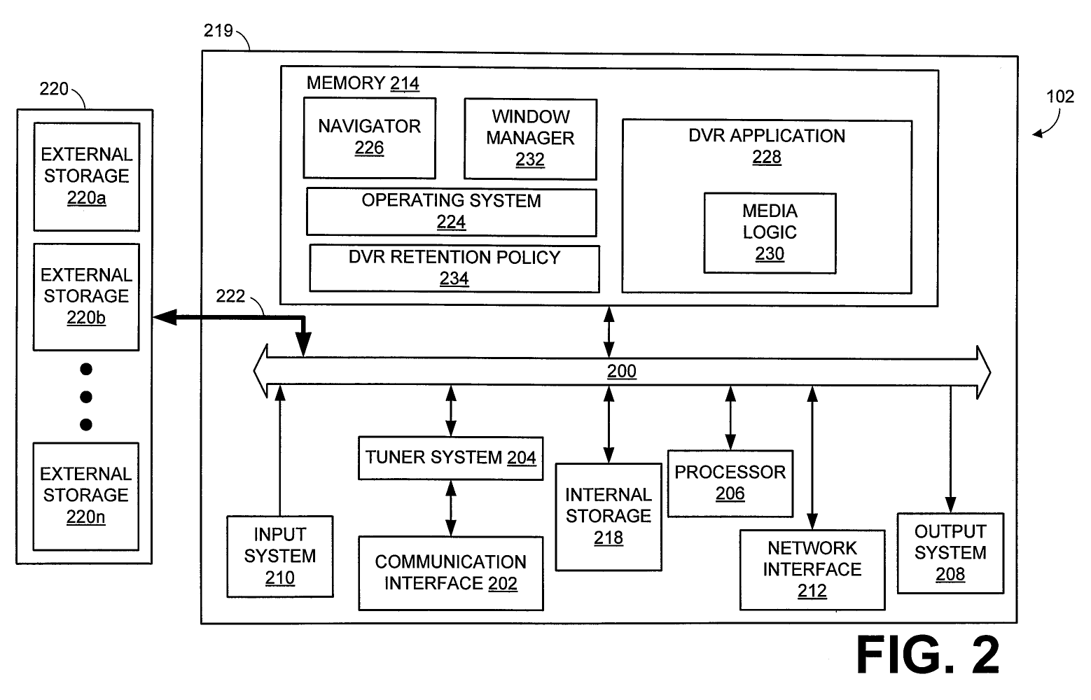

FIG. 2 is a block diagram depicting selected system components of an exemplary embodiment of the DVR 102 of FIG. 1. Omitted from FIG. 2 are a number of conventional components, known to those skilled in the art, that are unnecessary to explain the operation of the disclosed systems and methods for applying media retention rules. FIG. 2 depicts several components commonly communicating through a local bus 200. For example, DVR 102 includes a communications interface 202 for receiving video, audio and other media signals and, potentially, programming information from media signal source 104 (FIG. 1). Communications interface 212 comprises, for example, an Ethernet interface, an IEEE-1394 interface, a USB (Universal Serial Bus) interface, a serial interface, a parallel interface, a wireless radio frequency (RF) interface, a telephone line interface, a power-line interface, a coaxial cable interface, and/or an infrared (IR) interface, among others.

DVR 102 also includes a tuner system 204 for receiving and selecting one or more selected channels or streams of media content. For example, according to some instances, tuner system 204 can tune to a particular television channel or stream, and the media signals associated with this channel or stream are recorded by the DVR 102.

DVR 102 further includes at least one processor 206 for controlling the operations of the DVR 102 and an output system 208 for driving a playback device (e.g., television 106). An input system 210 receives user inputs provided via a wired or wireless input device such as, for example, a hand-held remote control, a transmitter with buttons or keys located on the exterior of the DVR, and/or a keyboard, among other potential input devices.

Network interface 212 transmits and/or receives data over a network such as a LAN, WAN, or the Internet. For example, data is transferred to/from another DVR, a media signal source, or a centralized server through network interface 212, among others. Memory 214, which can include volatile and/or non-volatile memory, stores one or more programmed software applications, routines, drivers, or other functional elements (herein broadly referred to as applications), which contain instructions that are executed by processor 206 under the direction of operating system 216. Input data used by an application is stored in memory 214 and read by processor 206 as needed during the course of the execution of the application. In some instances, this input data is data stored in memory 214 by a secondary application or other source, either internal or external to DVR 102. In other stances, data is created with the application at the time it was generated as a software application program. According to some embodiments, other logic is stored in memory 212 for operation of the DVR 102.

Internal storage 218 comprises a recordable medium and may be any of a number of devices available for non-volatile data storage, such as, among others, a hard disk drive (HDD), optical drive, or flash memory, for example. Although depicted as separate components, internal storage 218 and memory 214 are the same device in some embodiments. Among other uses, internal storage 218 is used for storing media content (i.e. in the form of media data) received through communication interface 202 and/or network interface 212. In some embodiments, before being stored on the recordable medium, the media content is digitally encoded by the DVR itself or by means external from the DVR, such as the media signal source or a cable set-top box. Media content is stored on the recordable medium in an encrypted or unencrypted state.

Like internal storage 218, external storage 220 also comprises a recordable medium for non-volatile data storage, such as, among others, a hard disk drive (HDD), optical drive, or flash memory, for example. However, unlike internal storage 218, which is located within the DVR enclosure (i.e., housing) 219, external storage 220 can be removably attached to DVR 102 through a communications interface 222. According to some embodiments, external storage 220 is located remotely from the DVR, such as in other rooms or locations within a house.

Although only one external storage medium is used in some embodiments, it is contemplated that other embodiments may comprise a plurality of external storage mediums 220a-220n. In some instances, for example, external storage mediums 220a-220n comprise a plurality of HDDs. It can be appreciated that the one or more HDDs can be combined to communicate with DVR 102 over one or more communication interfaces using a hub or other similar device. According to some embodiments, the external storage 220 is provided in a self-supporting, external housing. Some embodiments also include an integrated power supply for powering to the external storage and/or cooling devices, such as fans and/or heat dissipating devices.

According to some embodiments, communication interface 222 can be a high-speed communication bus, such as, among others, a bus operating under the Advanced Technology Attachment (ATA) standard, and more specifically, the Serial-ATA (i.e., SATA) standard version 2.5, which is available from the Serial ATA International Organization and is hereby incorporated by reference in its entirety. According to such an embodiment, DVR 102 includes a communications interface comprising an attachment port on the housing 219 of the DVR that cooperatively mates with the plug of external storage 220. A cable complying with the high-speed bus (i.e., a cable complying with the SATA standards) provides the transmission medium between external storage 220 and DVR 102.

According to some embodiments, the communication interface 222 is a bus complying with wired infrastructure and protocols, such as, for example, the IEEE 1394 (Firewire) standard or the Universal Serial Bus (USB) standard, among others. However, in some instances, the communication interface 222 is a wireless medium. According to one such a wireless embodiment, the external storage device 220 communicates with DVR 102 using a wireless protocol such as the IEEE 802.11 protocol, among others.

Some embodiments of DVR 102 include a communications interface comprising a slot or port for readily removable media. The readily removable media is, for example, flash memory, an HDD, optical media, and/or magnetic media, among others.

User input received during the course of execution of any processes implemented by DVR 102 are received from an input device (not shown) via input system 210, transmitted through the bus 200, at least temporarily stored within memory 214, and communicated to processor 206. Data generated by an application is stored in memory 214 by processor 206 during the course of the execution of the application. Availability, location, and amount of data generated by one application for consumption by another application is communicated by messages through the services of operating system 224, among others. Hence, preferences for the operation of the DVR functions is input by, among others, a subscriber using a remote and/or remotely under the control of an entity other than the user (e.g., by a command or other configuration change transmitted from the cable head-end). Changes to decision-making logic associated with the applications described herein are made by, among others, a variety of mechanisms under software control.

A navigator application 226 provides a navigation framework for services provided by DVR 102. Navigator 218 registers for, and in some cases reserves, certain user inputs related to navigational keys such as channel increment/decrement, last channel, favorite channel, etc. Navigator 218 also provides users with television (or other programming) related menu options that correspond to DVR functions such as, for example, providing an interactive program guide, blocking a channel or a group of channels from being displayed in a channel menu, recording particular channels, playback of recorded shows, etc.

Under user instruction, DVR application 228 performs the general tasks of recording and/or playing back received media content. Among other functions, DVR application 228 manages media content and related information. For example, according to some embodiments, DVR application 228 determines when and to which device the media content and related information will be stored to respective available storage devices. As well, as communication with storage devices is established or broken (e.g., by, among other possibilities, attaching and detaching external storage devices to the DVR), DVR application 228 performs a number of tasks to ensure that respective information associated with media content stored to the storage devices is managed accordingly. These aspects of DVR application 228, and others, will be described in more detail below.

According to some embodiments, DVR Application 228 includes media logic 230, which includes logic for applying retention rules associated with media content stored to a storage device associated with DVR 102. For example, according to some embodiments, logical rules determine which of the media content stored to internal storage device, external storage 220, and/or memory 214 can be deleted at a particular opportunity. Media logic 230 determines whether the logical rules have been met, and either retains or deletes the associated media content based on these rules.

Depending on the embodiment, it may or may not be desirable to apply media retention rules associated with media content stored to a first storage medium to media content stored to other storage mediums. Accordingly, in some embodiments, a DVR retention policy 234 can be used to determine whether media logic 230 is to apply retention rules associated with media content on a first storage medium to media data stored on any other storage mediums associated with DVR 102.

By way of example, one exemplary retention rule associated with one or more instances of media content defines how many episodes in a series of episodes of a particular television show are to be retained before deleting the older episodes in the series. Here, each episode in the series may correspond to an instance of media content, and the media logic 230 uses the retention rule to determine which of the instances of media content are to be retained and/or which instances could potentially be deleted to make room for newly recorded media content. Another exemplary retention rule could specify a duration of time (i.e. 3 days, 1 week, etc.) to keep an instance of media content before marking the instance of media content for deletion with media logic 230. It can be appreciated that a wide variety of potential retention rules associated with an instance of media content could be used.

Media logic 230 can be configured to delete instances of media content at any time after the logical retention rules are satisfied. According to some embodiments, media logic 230 is configured to delete instances of media logic only at a time when storage space is needed (e.g., in order to record another instance of media data). Thus, media logic 230 can be viewed, in some embodiments, as marking or flagging particular instances of media content as being capable of being deleted if necessary to make room for additional media content. How DVR retention policy 234 can be used by media logic 230 to apply the retention rules to the media content stored to the various storage mediums associated with DVR 102 will be described in more detail below.

Applications, such as navigator 226 and DVR application 228, among others, utilize services provided by window manager 232 and/or other graphics utilities provided by operating system 224 to draw dialog boxes, menus, graphics, etc., for display on playback device 106. Window manager 232, which in one embodiment is part of operating system 224, contains functionality for allocating screen areas and managing screen use among the various applications. Accordingly, window manager 232 provides the user interface for the DVR.

The applications executed by DVR 102 comprise executable instructions for implementing logical functions. In some instances, the applications are embodied in any computer-readable medium for use by, or in connection with, an instruction execution system. Some embodiments of the instruction execution system are, for example, a computer-based system, a processor-containing system, or any other system capable of executing or interpreting instructions. In the context of this document, a “computer-readable medium” is any means that can contain, store, communicate, propagate, or transport the program for use by or in connection with the instruction execution system, apparatus, or device.

Some embodiments of the computer-readable medium are, for example, among others, an electronic, solid-state, magnetic, optical, electromagnetic, infrared, or semiconductor system, apparatus, device, or propagation medium, either internal to DVR 102 or externally connected to the DVR 102 via one or more communication ports or network interfaces. More specific examples (a non-exhaustive list) of the computer-readable medium would include the following: an electrical connection (electronic) having one or more wires, a portable computer diskette (magnetic), a hard drive storage device (magnetic), a random access memory (RAM) (solid-state device), a read-only memory (ROM) (solid-state device), an erasable programmable read-only memory (EPROM or Flash memory) (multiple devices), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

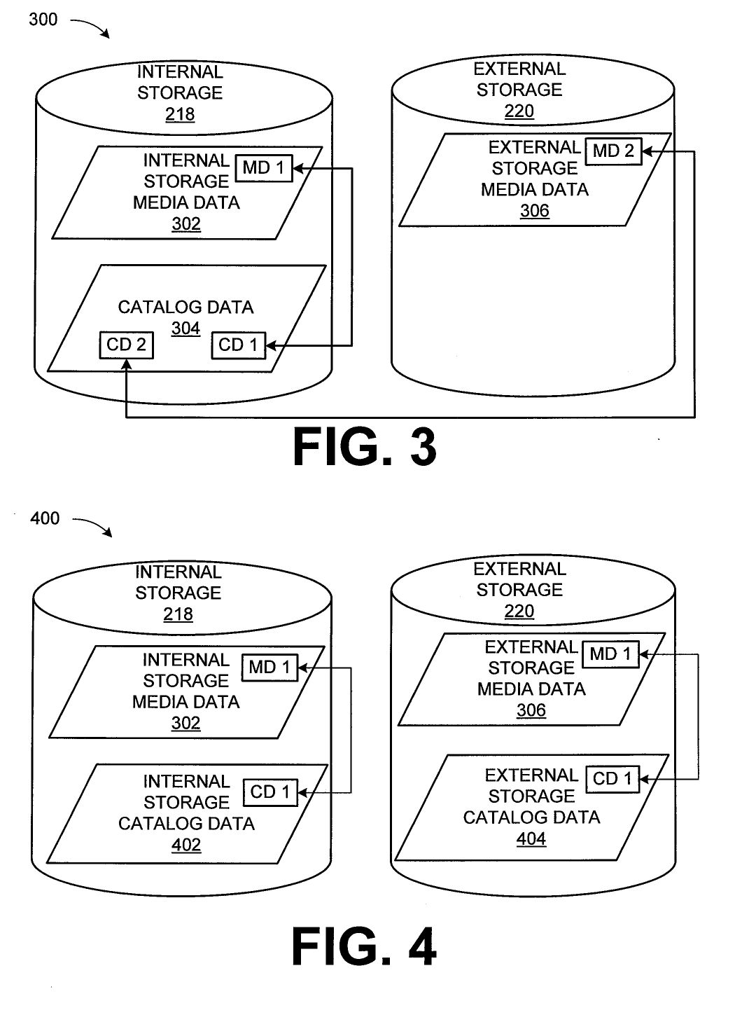

FIG. 3 depicts an embodiment of a data storage configuration 300 that can be used in association with the DVR 102 of FIG. 2. Specifically, the embodiment reflects one configuration used by DVR application 228 for storing media data and related information with respect to internal storage 218 and external storage 220. The media data stored to internal storage 218 and/or external storage 220 represents media content and thus these terms may be used interchangeably at times. Internal storage 218 can be used for the storage of such media data, depicted here as internal storage media data 302. Further, catalog data 304, which is information associated with internal storage media data 302 is also stored thereto. The catalog data 304 may include information about, among others, the media content associated with the internal storage media data 302, such as guide information (i.e. title, actors, genre, program description, channel, time, etc.), recording date, the storage locations (i.e. addresses, pointers to storage locations, etc.) of the associated media data, and/or trick play information, for example.

Catalog data 304, in some embodiments, includes the retention rules applicable to the particular instances of recorded media content. For example, such retention rules can define the number of episodes of a series to retain or an indication whether media data associated with the instance of media content can be deleted after a specified date.

Upon establishing communication with external storage 220, external storage media data 306 can be read from and stored to external storage 220. Thus, according to some embodiments, catalog data associated with external storage media data 306 is stored with the catalog data 304 on internal storage 218. Accordingly, in such embodiments, internal storage device 218 is used to store catalog data associated with both of internal storage media data 302 and external storage media data 306. Looking to FIG. 3, such associations are reflected in the depiction of an instance of media data MD1 (in internal storage media data 302) having an association with the catalog data labeled CD1. Similarly, an instance of media data MD2 (in the external storage media data 306) is associated with catalog data CD2.

Notably, according to such an embodiment, all of the catalog data (including any retention rules) for the respective instances of media data is located on internal storage 218. Accordingly, the catalog data pertaining to a plurality of storage mediums is stored to one of the storage mediums, while the media data associated with the catalog data is spread across multiple storage mediums (e.g., internal storage 218 and external storage 220). Thus, according to some embodiments, the catalog data used by the DVR 102 is stored to storage mediums other than the mediums used to store media data to which it shares an association.

FIG. 4 depicts another embodiment of a data storage configuration 400 that can be used within the DVR 102 of FIG. 2. Specifically, the embodiment reflects another configuration of the storage of media data and catalog data capable of use by, for example, DVR application 228. According to such an embodiment, like configuration 300, internal storage 218 includes internal storage media data 302 and external storage 220 includes external storage media data 306. However, according to configuration 400, catalog data associated with the media data stored to each medium is also stored to the respective storage medium. Thus, unlike configuration 300, internal storage 218 includes internal storage catalog data 402 and external storage 220 includes external storage catalog data 404. Accordingly, an instance of media content, represented as media data MD1 (in internal storage media data 302) is associated with the catalog data labeled CD1. Similarly, an instance of media content, represented as media data MD2 (in the external storage media data 306) is associated with catalog data CD2. Notably, the catalog data is stored to the same storage medium as its associated media data. Thus, external storage catalog data 404 comprises catalog information that is associated with the external media data 306, and internal storage catalog data 302 comprises catalog information that is associated with the internal media data 402.

According to one example, external storage 220 is portable and is capable of being transported between a number of DVRs. If the external storage catalog data 404 is not stored to external storage 220, the DVR to which it is attached is not capable of obtaining the catalog information for the associated shows from the external storage device. In some embodiments, the catalog information also includes the storage locations (i.e., addresses, pointers to storage locations, etc.) of the associated media data. Thus, according to such embodiments, the digital media device may not be able to retrieve the media data (i.e., for playback) without such storage location information. However, by co-locating the catalog data with its associated media data, a digital media recorder such as DVR 102 is able to read the catalog data from the portable storage medium in order to perform various operations on the associated media data.

Regardless of the storage location of the catalog data with respect to the media data, assuming that catalog information associated with media content stored to the various storage mediums is available, media logic 230 may use, among other information, the media data retention rules and other catalog data associated with an instance of media content for determining which instances of media content are, or are not, available for deletion from the various storage mediums.

For example, one exemplary media data retention rule could define that a particular instance of media content be deleted after a predetermined duration of time, such as one week. In such an example, media logic 230 refers to catalog data associated with the instance of media content to determine when the instance of media content was recorded and compares this to the current date and/or time to determine the duration of time. If the duration has passed media logic 230 determines that the instance of media content associated with that retention rule can be deleted.

As another example, in the case that an exemplary retention rule specifies that a specified number of episodes of associated media content in a series are to be retained, media logic 230 can access catalog data associated with other instances of media content to determine how many episodes of the media content have been recorded (e.g. by reviewing the titles or other identification information) to storage mediums associated with the DVR 102. If the number of episodes has been exceeded, media logic 230 can then determine which of the episodes should be deleted. For example, in some embodiments, media logic 230 determines this based on the oldest recorded episode and/or based on whether the episode has been viewed.

It should be understood that the above embodiments are merely examples, and a wide variety of retention rules are possible. For example, some media data retention rules are applied on a program-by-program basis (record a designated program and keep for X days or until deleted by a user), a series-by-series basis (record X episodes of this television series, and delete the episode having the oldest recording date), or on a storage space-remaining basis, among others. Regardless, in such embodiments, the catalog data stored to a respective storage medium can be accessed to determine which instances of associated media data to retain and/or delete.

In some instances, such rules can be applied by media logic at a time after establishing communication with a storage medium, such as after attachment of external storage 220 or establishing a wireless connection with external storage device 220. Another time for applying the retention rules with media logic 230 could include, but is not limited to, before recording a media instance, at the time of scheduling the recording of a media instance, or at a regularly scheduled time, among others.

However, depending on the embodiment, it may or may not be desirable to apply media retention rules based on content stored to other storage mediums. Accordingly, in some embodiments, a DVR retention policy 234 determines whether media data retention rules are to be applied to media data corresponding to instances of media content stored to other storage mediums associated with DVR 102. Thus, based on the selected DVR retention policy, the media logic can apply the logical rules based on the storage location of the media content. For example, the media logic can apply the retention rules based on whether the associated media content is stored to internal storage 218 and/or external storage 220, among other possibilities.

According to one exemplary DVR retention policy 234, the retention rules are applied to media content stored all storage devices associated with, or otherwise in communication with, the DVR 102. Thus, if an external storage device is attached to, or otherwise placed into communication with DVR 102, the media logic 230 refers to the catalog data on all storage mediums to determine whether media content is to be retained and/or deleted. Thus, any episodes of a series that appear on any associated storage medium are counted toward the maximum number of episodes to be retained. Additionally, in some embodiments, media logic 230 can refer to the catalog data of media content stored to external storage 220 to determine which of the episodes in the series are to be deleted (i.e. by looking to, among other catalog data, a date stamp indicating when the media content was recorded or a flag indicating that the media content has been viewed).

According to one non-limiting example, catalog data CD1 of internal storage catalog data 402 includes a retention rule for retaining only the last five recorded episodes of a particular television program. Meanwhile, external storage 220 may already include ten episodes of the television program which were, for example, recorded previously under different rules, or recorded with another DVR. After attaching external storage 220 to the DVR 102, media logic 230 applies the media data retention rules found in catalog data CD1 of internal storage catalog data 402 to the media data stored to external storage 220. According to such an embodiment, media logic 230 of DVR 102 accesses the external storage catalog data 404 and the internal storage data 402 to identify the last five recorded episodes of the television show and/or identify those episodes to be deleted.

In some embodiments, before media data of a particular instances of media content is deleted based on the media data retention rules, a user is prompted to ensure that media data is not unintentionally deleted. For example, according to one such embodiment, window manager 232 is used to display a GUI interface with a warning indicating that identified media data is going to be deleted (i.e., “Do you wish to delete this episode of Smallville?”). A user is able to select an option that either signals a confirmation of the deletion, or signals that the media data should not be deleted. This can be particularly helpful if the DVR retention policy 234 is applied to transient storage, such as external storage 220.

According to another embodiment of an exemplary DVR retention policy 234, the retention rules are applied by media logic 230 only to media content stored to internal storage 218, to the exclusion of the external disk. Such an embodiment can be advantageous to mitigate the possibility of media data being inadvertently deleted from external storage 220 if external storage 220 is routinely associated with a number of other media recording devices. For example, if the retention rules are applied only to media content stored to internal storage 218, any instances of media content stored to the external storage 220 are not considered in the application of the rules by media logic 230. For example, if an exemplary retention rule associated with an instance of media content stored to internal storage 218 defines that only five episodes of a series to which the media content is associated are to be retained, the media logic 230 searches only through the internal storage catalog data 402 that is associated with media content stored to internal storage 218 to determine the number of previously recorded episodes.

According to some embodiments of such a retention policy, retention rules are also not considered in the recording of media content to the external drive. Thus, even if media content stored to external storage 220 has associated media retention rules that indicate that up to five episodes of Star Trek are to be recorded and retained on external storage 220, such episodes will not be recorded.

Further, according to some embodiments, even if media content is recorded, moved, copied, or otherwise stored to external storage 220, such media content will not cause other media content stored to external storage 220 and/or internal storage 218 to be deleted according to media retention rules associated with media content stored to internal storage 218 and/or external storage 220.

However, according to yet another exemplary DVR retention policy 234, the retention rules are applied by media logic 230 to media content stored to respective storage locations, or groups of storage locations independently of the media content stored to other respective storage locations, or groups of storage locations. That is, in this exemplary policy, both the internal and the external storage have their own media-retention rules which are applied, and the media-retention rules for external storage are potentially applied, for example, every time an external-storage unit is attached to a DVR. This is in contrast to the previous embodiment, where the internal storage 218 has media-retention rules which are applied but the external storage effectively had no rules (i.e. any retention rules were not applied to the media content stored to external storage 220).

For example, according to one embodiment, the retention rules found in internal storage catalog data 402 are applied to all media content stored to internal storage 218 (i.e. the media content stored as internal storage media data 302) independently of the media content stored to external storage 220 (i.e. the media content stored as external storage media data 306). Thus, according to such an embodiment, any instances of media content stored to the external storage 220 are not considered in the application of retention rules by media logic 230 when applying the retention rules associated with content stored to internal storage device 218.

For example, according to one embodiment, if an exemplary retention rule associated with an instance of media content stored to internal storage 218 defines that only five episodes of a series to which the media content is associated are to be retained, the media logic 230 uses only the catalog data associated with the media content stored to internal storage 218 (i.e. internal storage catalog data 402) to determine the number of previously recorded episodes. Likewise, if an exemplary retention rule associated with an instance of media content stored to external storage 220 defines that only five episodes of a series to which the media content is associated are to be retained, the media logic 230 searches only through the catalog information associated with media content stored to external storage 220 to determine the number of previously recorded episodes.

As yet a further explanation, consider an embodiment in which both internal storage 218 and external storage 220 include retention rules indicating that, at most, five episodes of the television show Star Trek are to be retained. Further, while the retention rules associated with internal storage 218 indicate that all episodes are to be recorded, the retention rules associated with external storage 220 limit the recordings to first-run episodes, to the exclusion of re-runs. Using a retention policy that applies media logic 230 to media content stored to respective storage locations, the DVR 102 is able to record and/or retain a total of ten episodes of Star Trek, five on internal storage 218 and five on external storage 220, while deleting any extra episodes (e.g. the earliest recorded episode) to make room for the newly recorded episodes. Further, only first-run episodes are recorded on external storage 220, while any type of episode (i.e. re-run or first-run) of Star Trek could be recorded to internal storage 218.

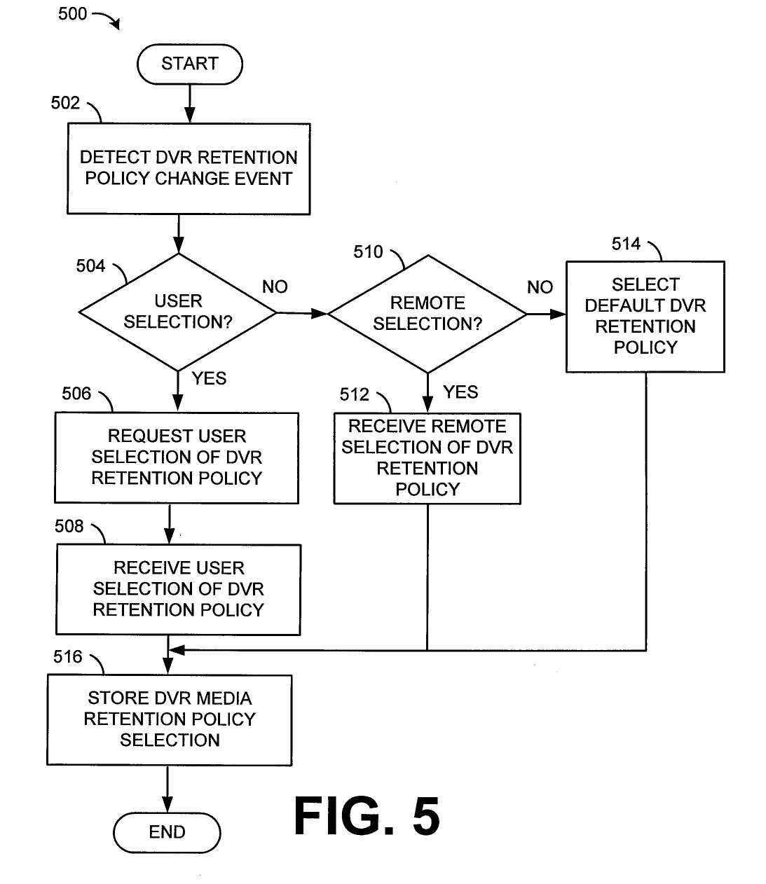

Accordingly, FIG. 5 depicts a process flow diagram of a process 500 for selecting a DVR retention policy 234 to be applied to one or more associated storage devices, such as internal storage 218 and/or external storage 220. At block 502, a retention policy change event is detected. In one embodiment, a retention policy change event could be a user desired configuration change facilitated through a graphical user interface where input for the selection is received through input system 210. According to some embodiments, the change event could be the detection that free-space on one or more of the media storage devices has dropped below a threshold. A retention policy change event could also be a message from a remote server, such as a cable head-end, that indicates that a policy change is requested. According to yet another embodiment, the retention policy change event is based on the detection of communication with a storage medium. For example, depending on the particular embodiment, this detection is triggered as a result of a storage device having media data stored to an associated storage medium being physically connected to the DVR 102 to establish the communication or being placed in wireless communication with the DVR 102 to establish the communication, among others. According to some embodiments, the establishment of communication triggers a system signal which can be used by DVR application 228 as an indication that the communication has been established with the storage device, which could be, among others, external storage 220, internal storage 218, and/or with a storage device used to read and/or write to readily removable media.

At decision block 504, if the DVR 102 is configured to allow user selection (the YES condition), block 506 is executed to request user selection of a DVR media retention policy 234. For example, a GUI can be displayed to the user asking the user to select one of a plurality of potential retention policies to use. According to one embodiment, a user might select between an option for globally applying retention rules globally to media data stored to all storage devices, to a single storage such as internal storage 218 and/or external storage 220, or a policy that treats each storage location or groups of storage locations independent of other storage locations. At block 508, such a user selection of the retention policy can be received through input system 210.

However, if at decision block 504, if the retention policy change event is not a user selection (the NO condition), at decision block 504 the DVR application 228 determines whether the retention policy change event is a remote selection, such as the receipt of a retention policy change request from a cable-head end or other remote server. In the case that the selection is remotely requested (the YES condition), at block 512 the remote selection is received by DVR application 228. For example, the retention policy change request can identify the remote selection of a DVR retention policy 234 or the DVR 102 could be configured to request the selection of the DVR retention policy 234 from the remote server upon receiving the retention policy change request.

If, at decision block 510, the retention policy change event is not a user selection or a remote selection (the NO condition), at block 514 DVR 102 can be configured to select a default DVR media retention policy 234. For example, this may be used in the case of an initial initialization of the DVR, or in embodiments of DVR 102 in which the DVR media retention policy 234 is not user or remotely selectable.

Regardless of how the DVR media retention policy 234 is selected, at block 516 the DVR media retention policy selection is stored to a storage location, such as memory 214, internal storage 218, and/or external storage 220, among other possible storage locations.

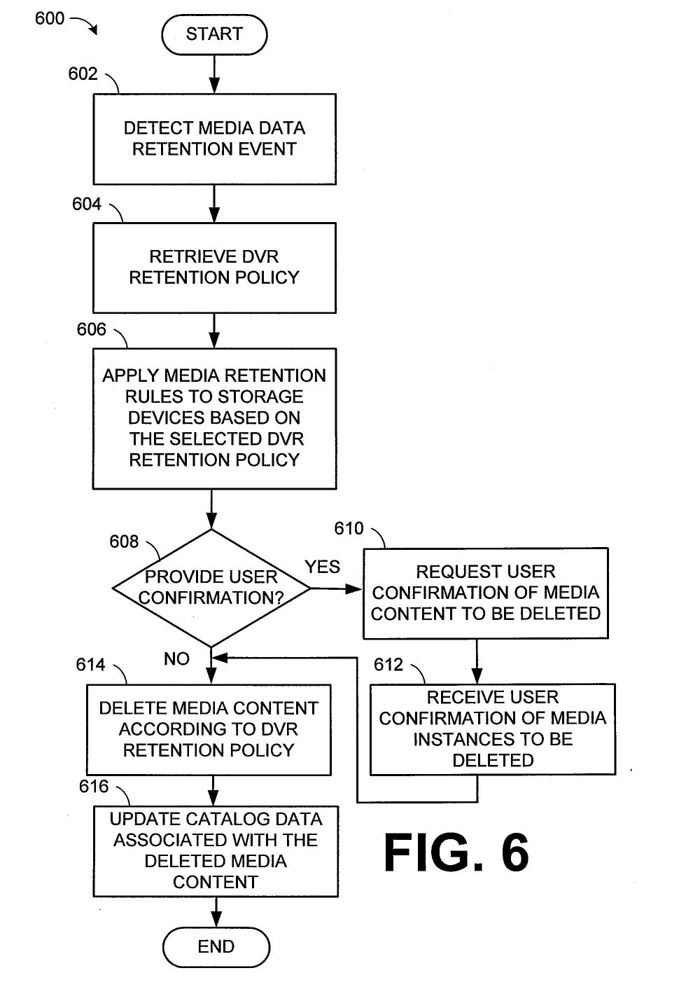

Now that a process for selecting a DVR retention policy has been described, FIG. 6 depicts a process for applying media retention rules to storage mediums based on the selected DVR retention policy. For example, as depicted at block 602, the media data retention rules may be applied upon DVR application 228 detecting a media data retention event, which could be, for example, generated as a result of a new DVR retention policy 234 being selected (i.e. after completing process 500 of FIG. 5), the DVR determining that an instance of media content is to be recorded, the DVR determining that storage space is needed, an instance of media content is scheduled to be recorded in the future, among other possible events that could trigger such a media data retention event.

In one exemplary embodiment, a media data retention event is triggered in order to create storage space for recording a new instances of media content to a storage device associated with the DVR 102, such as to internal storage 218 and/or external storage 220. For example, a request to record an instance of media content can be received from a scheduler application that is configured to record programs at previously scheduled times. However, in some instances, the request is generated at the request of a user. For example, in some instances, a user is able to indicate that a program appearing on a selected channel is to be recorded by pressing a record button on a remote control device that is configured to emit signals to the DVR. The storage space needed to record the instance of media content can be determined or estimated by DVR application 228. In some embodiments, such a determination can be an estimate based on, among others, the length of the program and/or a recording quality to be used (e.g., defining a resolution, bit rate, and/or frame rate, among other factors). Once determined, if necessary, the media data retention rules can be applied according to the DVR retention policy 234 to determine which, if any, previously recorded media content can be deleted to ensure that enough storage space is available for storing the new instance of media content.

At block 604, according to some embodiments, DVR application 228 retrieves the current DVR retention policy. For example, DVR application 228 could access the current DVR media retention policy 228 that is stored in memory 214. At block 606, the media retention rules are applied to the media content stored to storage mediums associated with DVR 102 based on the current DVR media retention policy, as described above.

At decision block 608, some embodiments may request user input to determine whether to apply the rules to particular media content to avoid inadvertent deletion of associated media data. According to some embodiments, such a user confirmation embodiment is user configurable. That is, in such an embodiment, a user is given a choice to select whether or not a user confirmation interface is to be generated to confirm that media content is to be deleted from a particular storage device.

Accordingly, if such a feature is included (the YES condition), at block 610, the user is requested to confirm the deletion of media content to be deleted. For example, a graphical user interface may be displayed within display device 106 that indicates one or more instances of media content that the media logic has identified, using the DVR retention policy and retention rules, that will be deleted or marked for deletion.

At block 612, the user confirms or cancels the deletion of the identified one or more instances of media content. For example, a user may interact with the graphical user interface displayed in block 614 by selecting an “OK” button to confirm the deletion or a “CANCEL” button to cancel the deletion of the identified media content.

At block 614 the identified, and potentially confirmed, instances of media content are deleted from the appropriate storage medium. For example, media data stored on one or both of internal storage 218 or external storage 220 is deleted. According to some embodiments, the identified, and potentially confirmed, instances of media content are marked for deletion at this time, and the media content is deleted at a later time, such as when space is needed for storing new media content.

At block 616 catalog data associated with the deleted media content is updated. For example, the catalog data associated with the deleted media content can be removed from internal storage catalog data 402 and/or external storage catalog data 404. For example, where the catalog data includes information such as the title of the deleted media content, actors associated with the deleted media content, or the date deleted media content is recorded, among others, the catalog data is updated to reflect that any associated media content has been deleted.

According to some embodiments it can be advantageous to select a retention policy that excludes the deletion of media content from one or more of the storage devices. For example, in the case that one or more external storage devices 220 are used for archiving desired media content, the retention policy can be configured not to allow deletion of media content on the external storage device by media logic 230. In such an embodiment, it can also be advantageous to combine such a configuration with the additional ability for the DVR 108 to copy or move media data between the storage devices to provide for redundancy or archival functionality.

For example, FIG. 7 depicts an embodiment of a process 700 that can be used to implement redundancy and/or archival functionality to DVR 102. According to one embodiment, for example, at block 702 a DVR retention policy 234 is selected that is configured to apply media data retention rules only to a first storage medium, while excluding other storage mediums. According to one embodiment, for example, the DVR retention policy is configured to apply retention rules to internal storage 218, while excluding the application of the media data retention rules to media content stored to external storage 220. Accordingly, media logic 230 does not delete or mark for deletion, the media content stored to storage device 220.

At block 704, according to one embodiment, a user can request that one or more instances of media content be copied from the first storage medium to a second storage medium. For example, a user interface can be displayed to a user allowing the user to view the titles or other identifying information about content stored to associated storage devices. In some instances, it may be beneficial to allow the user to filter the content based on the storage medium (e.g. view only the identification of media content stored to internal storage 218 and/or external storage 220). The user can then select the desired instances of media content to be copied to the second storage medium through the graphical user interface. For example, a user may select one or more episodes of the television show “Smallville” (previously recorded to internal storage 218) to be copied from internal storage 218 to external storage 220.

At block 706, once the media content has been selected, the selected media content is copied from the first storage medium to the second storage medium. Keeping with the above example, the selected episodes of “Smallville” are then copied from internal storage 218 to external storage 220. That is, the underlying media data is transferred to external storage 220. Additionally, according to some embodiments, the catalog data associated with the one or more episodes could also be copied to the second storage medium.

In some cases, it is desirable to provide a back-up or secondary copy of desired media content on the second storage device. Thus, according to some embodiments, at decision block 708, if a back-up or secondary copy of the media content stored to the first medium is to be retained at the first medium (the YES condition) the process 700 ends, allowing the media content to exist on both the first and second storage mediums. Thus, keeping with the above example, the episodes of “Smallville” copied to the second storage medium are retained on the first storage medium as well. The episodes of “Smallville” retained on the first storage medium may, in some embodiments, be subject to the selected DVR retention policy and retention rules, while the episodes of “Smallville” copied to the second storage medium are not.

However, in some embodiments, (e.g. the NO condition of block 708) it is desirable to move the desired media content to the second storage medium, thereby deleting the original media content stored to the first storage medium after the copy operation is completed (e.g. block 706). Accordingly, at block 710, the original media content is deleted from the first storage medium.

It should be understood that any embodiments of process 700 described in terms of copying or moving media content and/or its associated catalog information from internal storage 218 to external storage 220 could also be applied equally to copying or moving the media content and/or its associated catalog information from external storage 220 to internal storage 218. For example, a user may wish to copy the one or more episodes of “Smallville” from external storage 220 to internal storage 218. Such an activity could be beneficial to free up storage space on external storage 220 and/or to allow the episodes to be accessed for playback from internal storage 218 even if external storage 220 is removed.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, steps, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the preferred embodiments of the systems and methods described herein in which steps or functions may be deleted, executed out of order from that shown or discussed, including substantially concurrently or in reverse order, depending on the functionality involved, as would be understood by those reasonably skilled in the art.

It should be emphasized that many variations and modifications may be made to the above-described embodiments, the elements of which are to be understood as being among other acceptable examples. All such modifications and variations are intended to be included herein within the scope of this disclosure and protected by the following claims.

At least the following is claimed:

1. A method comprising:
recording instances of media content to a first storage medium associated with a digital media recorder;
detecting that a second storage medium is available for storing and maintaining additional instances of media content associated with the digital media recorder; and
at a time after detecting that the second storage medium is available for storing and maintaining additional instances of media content, determining at least one of the instances of media content stored to the first storage medium or second storage medium can be deleted based on a retention policy that applies selected media retention rules associated with the instances of media content based on the storage medium to which the media content is stored.

2. The method of claim 1, wherein the retention policy applies the retention rules based on whether the media content that can be deleted is stored to the first storage medium or the second storage medium, the first storage medium associated with an internal storage device and the second storage medium associated with an external storage device.

3. The method of claim 1, wherein the retention policy considers the media content stored to both of the first and second storage mediums when applying the media retention rules.

4. The method of claim 1, wherein the retention policy applies retention rules associated with the media content on one of the first and second storage mediums differently than the retention rules associated with media content on the other of the first and second storage mediums.

5. The method of claim 4, wherein the retention policy applies the retention rules associated with media content stored to the first storage medium without considering the media content stored to the second storage medium.

6. The method of claim 1, wherein determining whether the instances of media content stored to the first storage medium or second storage medium can be deleted is performed in response to establishing communication with a device for reading and writing media content to one of the first or second storage mediums.

7. The method of claim 1, further comprising:
detecting a retention policy change event;
receiving a selection of the retention policy to be applied to storage mediums associated with the digital media recorder; and
storing the selected retention policy.

8. The method of claim 7, further comprising:
receiving a user selection of media content to be copied from the first storage medium to the second storage medium; and
copying the selected media content from the first storage medium to the second storage medium.

9. The method of claim 8, further comprising:
deleting the copied media content from the first storage medium.

10. A system comprising:
an enclosure having:
an input, on the outside of the enclosure, for receiving instances of media content from a media source;
an output for transmitting the media signals to a display;
a first storage device, inside the enclosure, for storing at least a portion of the instances of media content; and
a high-speed data port, accessible from outside of the enclosure, configured for connecting a second storage device for storing at least a portion of the media content;
media logic configured to determine at least one of the instances of media content stored to the first storage device or second storage device can be deleted based on a retention policy that applies selected media retention rules associated with the instances of media content based on the storage device to which the media content is stored.

11. The system of claim 10, wherein the retention policy considers the media content stored to both of the first and second storage devices when applying the media retention rules.

12. The system of claim 10, wherein the retention policy applies retention rules associated with the media content on one of the first and second storage devices differently than the retention rules associated with media content on the other of the first and second storage devices.

13. The system of claim 12, wherein the retention policy applies the retention rules associated with media content stored to the first storage device without considering the media content stored to the second storage device.

14. The system of claim 10, wherein the media logic is further configured to determine whether the instances of media content stored to the first storage device or second storage device can be deleted in response to establishing communication with the second storage device.

15. The method of claim 10, further comprising:
detecting a retention policy change event;
receiving a selection of the retention policy to be applied to storage devices associated with the digital media recorder; and
storing the selected retention policy.

16. The method of claim 15, further comprising:
receiving a user selection of media content to be copied from the first storage medium to the second storage medium; and
copying the selected media content from the first storage device to the second storage device.

17. A digital media device comprising:
logic configured to record instances of media content to a first storage medium associated with a digital media recorder;
logic configured to detect that a second storage medium is available for storing and maintaining additional instances of media content associated with the digital media recorder; and
logic configured to, at a time after detecting that the second storage medium is available for storing and maintaining additional instances of media content, determine at least one of the instances of media content stored to the first storage medium or second storage medium can be deleted based on a retention policy that applies selected media retention rules associated with the instances of media content based on the storage medium to which the media content is stored.

18. The digital media device of claim 17, wherein the retention policy applies retention rules associated with the media content on one of the first and second storage mediums differently than the retention rules associated with media content on the other of the first and second storage mediums.

19. The digital media device of claim 17, further comprising:
logic configured to detect a retention policy change event;
logic configured to receive a selection of the retention policy to be applied to storage mediums associated with the digital media recorder; and
logic configured to store the selected retention policy.

20. The digital media device of claim 19, further comprising:
logic configured to receive a user selection of media content to be copied from the first storage medium to the second storage medium; and
logic configured to copy the selected media content from the first storage medium to the second storage medium.

21. The digital media device of claim 20, further comprising:
logic configured to delete the copied media content from the first storage medium.

22. The digital media device of claim 17, further comprising:
logic configured to determine whether the instances of media content stored to the first storage medium or second storage medium can be deleted in response to establishing communication with an external storage device associated with the second storage medium.
